(19) United States
(12) Patent Application Publication
(10) Pub. No.: US 2003/0107488 A1
(43) Pub. Date: Jun. 12, 2003

(54) Wild-life registration system

(76) Inventor: Maurice H.P.M. van Putten, Cambridge, MA (US)

Correspondence Address: Maurice H.P.M. van Putten, 266 Pearl Street, Unit A, Cambridge, MA, 02139, US

(21) Appl. No.: 10/012,236

(22) Filed: Dec. 11, 2001

(51) Int. Cl. G08B 23/00

(52) U.S. Cl. 340/573.2; 340/539.13

(57) ABSTRACT

A wild-life registration system is described for tracking migration trajectories. The system consists of a wireless network of smart multi-sensors with GPS. The sensors include digital threshold control and data compression. An ad-hoc routing protocol allows the network to be fault-tolorant, scalable and adaptive. Tracking trajectories—finite curves in the plane—minimizes the required number of sensors to N≅10⁶(A/10⁶ km²)(r/50 m)⁻¹(d/km)⁻¹, where r denotes the radius of detection sensitivity of the sensors and d the desired interpolation distance d of trajectories, given a desired surface area coverage A. The preferred embodiment uses silicon integrated multi-sensors housed in a rugged probe for insertion into or placement on the natural soil, equipped with stand-alone power supply. The preferred method of employment uses aerial droppings by plane.

### SUMMARY

A Wild-life Registration System (WRS) is described for real-time and faithful registration of wide-area migration processes over the internet. The method tracks migration by interpolation of their trajectories using a large network of multi-sensors. Targeting trajectories dramatically relaxes the required number of sensors, compared with transient events at points. The system is integrated into the internet by wireless sensor-to-sensor communication. The intended multi-sensor comprises omni-directional audio-visual monitoring with GPS coordinatization. Smart multi-sensing performes on-site analysis and selection of stimuli above background for transmittal to a central processing station. WRS offers “a million points of sight” for long-term monitoring, statistical analysis and predictions of migration in remote and uninhabitable territories.

### BACKGROUND OF THE INVENTION

Tracking migration is a common challenge in wild-life sciences (Bulusu et al., 2000), notably so in marine biology. The emergence of modern silicon integrated sensing technology and wireless communication devices suggest to look for ways to obtain high-resolution sensor-networks for real-time tracking of migration trajectories. This would provide faithful representations of migration processes for in-depth statistical analysis and identification of predictive behavior. Statistical analysis on migration trajectories is potentially invaluabe in behavioral science: collective behavior in migration over different routes, and diversification across different species. Studies of this kind may also correlate with climate changes and agricultural developments. The envisioned computerized data analysis could be invaluable in long-term and non-interfering monitoring strategies of migrations at remote and uninhabitable territories. These considerations have motivated the present disclosure of a Wild-life Registration System (WRS) for monitoring migration.

Present approaches to tracking wild-life aim at obtaining high spatial resolution of transient events at points. In fact, such point-wise approaches are a common denomenator in the state of the art of remote sensing and sensor-networks: see Cunningham et al. (2000), Agre et al. (2000), Kail & Karl (2001) and Vaios (2000) and references cited therein. High spatial resolution in two dimensions rapidly becomes prohibitively expensive in attempts to cover a large surface area, e.g, a medium sized country. The present disclosure, therefore, is different. Here, we emphasize tracking migration trajectories by way of interpolation. Focus on trajectories rather than transient events considerably relaxes the required surface area coverage and, commensurably, the required number of sensors. A simple calculation may illustrate this. Consider detecting and tracking trajectories over intervals of approximately d=10 km within a surface area A=10⁶ km². Using sensors with a radius of sensitivity of r=50 m gives rise to N=10⁶ sensors. Their collective surface sensitivity area constitures a mere 0.25% of the surface area—a relative savings by a factor of about 400 relative to point-targeting approaches.

WRS offers a new low-cost method for real-time tracking of migration trajectories. In common with existing approaches, it aims at establishing a wireless sensor network covering a large surface area, while providing remote access at a central processing station. Modern approaches to reduce cost or, equivalently, enhance the number of sensors comprise the use of off-the-shelf components. NASA's Beowulf parallel computing experiment serves as an excellent example of this approach. All components of WRS are standard and in commercial production. The new advance in WRS arises as the sum of these, upon integration of these components into a single mass-produced VLSI chip in the preferred embodiment disclosed below. This integration shall be described for standard audio-visual monitoring combined with coordinatization from the Global Positioning System (GPS) and provisions for wireless sensor-to-sensor communication by ad-hoc routing.

Deployment of WRS over a country-sized area requires a large number of sensors to achieve the required high spatial resolution in interpolating trajectories. The proposed method of installation uses aerial droppings by airplane. This method will generally aim at covering the region with an approximately uniform grid of sensors. The grid may be enhanced locally in places of special interest (local grid refinement), or changed over the course of time (adaptive grid). In the example above, for example, a uniform grid has one sensor per 1 km², corresponding to a grid of 1000×1000 points. Equivalent to a linear distance of about 10⁶ km, this is may be covered by areal droppings in a one-week effort by ten planes flying at 500 km/hr. The preferred embodiment, therefore, is a solid state probe sufficiently rugged to permit high-altitude droppings in combination with soft landings using inflated cushions (see recent Mars landing experiments).

To summarize, WRS offers “a million points of sight” to detect and track migration trajectories over the Internet, using a wireless network of multi-sensors. It serves to study collective and predictive behavior in wild-life. WRS interpolates migration trajectories using a two-dimensional grid of sensors featuring:

(1) silicon multi-sensors with GPS and wireless communication ports, notably with audio-visual sensing capability,

(2) integration into a network by ad-hoc routing, providing fault-tolerance, scalability and allowing for adaptive grid-refinement,

(3) smart sensors with digital thresholds and data compression to minimize data transmission, permitting long-term stand-alone operation on battery and solar power,

(4) rapid and efficient deployment by aerial droppings of the sensors, housed in a rugged probe with provisions for soft landings.

### SUMMARY OF THE INVENTION

The method disclosed herein pertains to remote sensing of migration trajectories of wild-life across large surface area terrain. The intended coverage is two-dimensional, focusing on the interpolation of trajectories—one-dimensional curves of finite length—in contradistinction from the detection of local events as points on the plane. This focus permits a fairly low coverage of the physically monitored surface area, while maintaining a comprehensive coverage of trajectories therein.

The method comprises three components: a smart multi-sensor with on-chip computing capability, a GPS receiver and a wireless communication port, and a stand-alone power supply. The preferred embodiment described below envisions these three components to be integrated on a single VLSI silicon-integrated chip and housed into a small and rugged probe. Small and low-power probes such as these are thereby amenable to mass-production, and easy deployment by areal droppings from the sky at the required large numbers over a wide surface area.

The smart multi-sensor is envisioned to contain audio-visual recording capability whose operating range extends over a predefined radius, e.g., r=50 m. The audio-visual senser can be integrated on a single VLSI silicon-integrated chip using commercial processes, wherein accoustic sensing is electrostatic and optical sensing uses charge-coupled devices (CCD). Inclusion of a microprocessor, such as a low-cost ATMEL unit, permits local data analysis and threshold control. Threshold control is important in having the sensor transmit data into the network only when triggered by an anomalous event. Anomalous signals may pertain to prompt audio or optical signals, different from the average or steady-state background signals. Minimizing data transmission is crucial for long-time stand-alone operation given a limited power supply in stand-alone applications.

A GPS receiver is integrated with each sensor for accurate localization and independence of operation within the system. While relative localizations between sensors have been considered successfully using radio, fault-tolerant and scalable operation form an important property of the intended sensor-network. Individual GPS localization permits maximal fault-tolerance, due to either malfunctioning or removal of a unit, and trivial scalability. Notice that inclusion of a GPS receiver to each sensor poses no significant burden on the power supply, as it requires—in principle—only a single initial reading upon placement of the unit to its fixed location.

Connection to a wireless digital communications network is envisioned using commercially available digital mobile phone technology, to cut development cost and time. These units are presently manufactured at volumes of a few hundred million units per year. (The mean time-to-replacement of a mobile phone is presently less than one year.) This large-scale volume makes advanced digital communication technology available at reasonable cost.

Power requirements form an important constraint of the system. We anticipate that instantaneous power consumption is dominated by wireless data transmission (e.g., at 1 Watt). This calls for transmitting data “only when necessary,” and, perhaps so, in combination with data compression. This suggests local data processing and selection and, upon transmittal, data compression. Long-duration, low-power supply is generally considered through a combination of battery power and solar panels. While the former is robust but finite, the latter is infinite but susceptible to weather conditions. In particular, solar panels will be inoperative at night and when covered by snow. This is conceivably a source of failure and, in addition to regular technical malfunction, serves to illustrate a possible need for replacements.

The data gathered by the sensors is transmitted over the sensor-network to a common processing site by ad-hoc routing (Perkins 2001). The sensor-network forms a two-dimensional graph, wherein each sensor represents a vertex. Consider all vertex to be linearly numbered, i.e., we have vertices {Sᵢ}ᵢ₌₁^{N} with GPS coordinates {(xᵢ, yᵢ)}ᵢ₌₁^{N}. We shall assume that the central processing unit is at S_{N}. A message from vertex Sᵢ is transmitted to S_{N} by point-to-point transmissions (PPT, see below) over edges linking neighboring vertices. The primary objective is to ensure that the message arrives at S_{N} within a reasonable time. To this end, we assume that the graph is connected. A message from sensor Sᵢ propagates over the network by tracing a route, defined by the sub-graph spanned by the elements

R(k)={Sₙ_{₁}, Sₙ_{₂}, . . . , Sₙ_{ₖ}}(n₁=i). (1)

While Sₙ_{ₖ}≠S_{N}, the route is incomplete. Upon arrival at S_{N}, the route completes into

R*={Sₙ_{₁}, Sₙ_{₂}, . . . , Sₙ_{ₗ}, S_{N}}. (2)

The message is transmitted over the network by extending R(k) to higher k. This comprises selection of a new neighbor to Sₙ_{ₖ} to be listed in R(k), based on a local optimization (see below). If such neighbor exists, then

R(k+1)={Sₙ_{₁}, Sₙ_{₂}, . . . , Sₙ_{ₖ₋₁}, Sₙ_{ₖ}, Sₙ_{ₖ₊₁}}, (3)

where Sₙ_{ₖ₊₁} is not already contained in R(k). If such neighbor does not exist, i.e., the message arrives at a dead-end, then it bounces:

R(k+1)={Sₙ_{₁}, Sₙ_{₂}, . . . , Sₙ_{ₖ₋₁}, Sₙ_{ₖ}, Sₙ_{ₖ₋₁}}. (4)

In this case, a either a new branch forms off Sₙ_{ₖ₋₁} or the message bounces back one more time. Thus, the message bounces back until it can branch off in a new direction. This routing may be illustrated as follows. Consider a route with four elements,

R(4)={S₁, S₃, S₂, S₅}. (5)

If the fourth element S₅ is not a dead-end, PPT will select a suitable neighbor which extends it to

R(5)={S₁, S₃, S₂, S₅, S₇}. (6)

If S₅ is a dead-end, the message bounces. A new branch may form at S₂, which would give

R(5)={S₁, S₃, S₂, S₅, S₂, S₉}, (7)

or it may form at S₃, which would give

R(5)={S₁, S₃, S₂, S₅, S₂, S₃, S₈}. (8)

While this routing algorithm is robust in taking messages from Sᵢ to S_{N}, in that it depends merely on connectivity of the graph, it is evident that efficient data transmission requires dead-ends to be rare. In particular, a uniform grid will allow for approximately linear scaling of the transmission time with pysical distance between Sᵢ and S_{N}.

The point-to-point transmission (PPT) of data over the sensor-grid follows a certain protocol for local optimization. Sₙ_{ₖ} pings all its neighbors. Those, e.g., Sₙ_{ₗ} and Sₙ_{ₘ}, that can physically receive this signal reply with broudcasting their coordinates. Sₙ_{ₖ} subsequently compares their (indexed) coordinates, i.e.: {nₗ, (xₙ_{ₗ}, yₙ_{ₗ})} and {nₘ, (xₙ_{ₘ}, yₙ_{ₘ})} in the present example, and determines which is closest to the reference coordinates of S_{N}. Let Sₙ_{ₗ} be closest to S*, which is not already in R(k). Sₙ_{ₖ} subsequently transmits a data structure {message, R(k+1)} to Sₙ_{ₗ}, wherein R(k+1) is formed by appending Sₙ_{ₗ} to R(k). Sₙ_{ₗ} now repeats this sequence: it pings its neighbors, selects Sₙ_{ₚ} as the neighbor closest to S_{N} not already in R(k+1), and transmits {message, R(k+2)} to Sₙ_{ₚ}. In this fashion, the message propagates approximately linearly from Sᵢ to S_{N}.

### SURVEY OF THE DRAWINGS

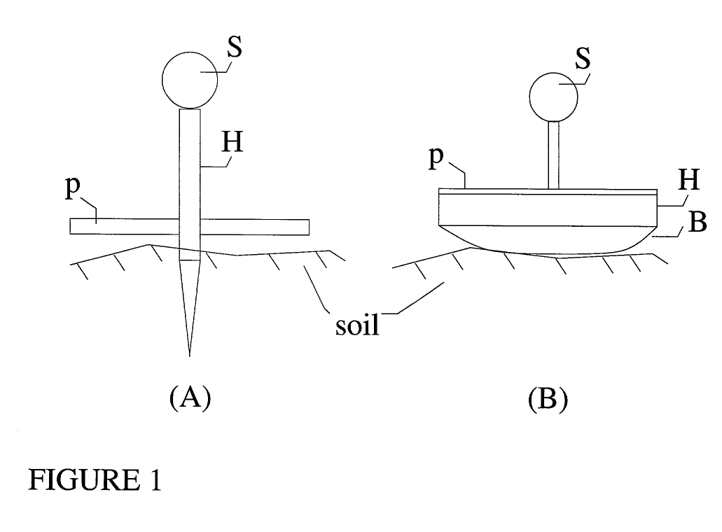

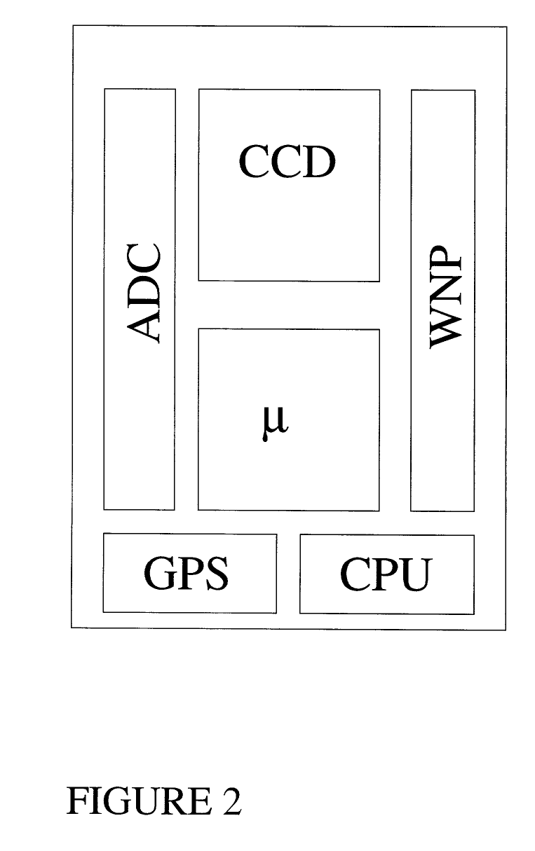

Implementation of the WRS-probes is shown in FIG. 1 and the layout of its silicon-integrated smart multi-sensors is shown in FIG. 2.

Regarding placements of the probes in the terrain of interest, the implementations shown in FIG. 1 pertain to an elongated probe (a) inserted vertically in the soil, and a flat probe (b) resting on the soil with no insertion. The first permits a relatively higher outlook on the suroundings and is less likely to be covered by snow than the second, provided the soil permits vertical insertion of the supporting pole. The second is more amenable to placement on hard or rocky soil, but is less suitable under adverse wheather conditions such as snow. These two alternatives provide some flexibility to the terrain of interest, e.g., hills, forestry, mountains, soil composition and different wheather conditions.

The two probes as shown schematically in FIG. 1 are both suitable for droppings from the sky. With appropriately low center of gravity, e.g., provided by the batteries down the pole (H) in FIG. 1(a) and in the bottom (B) in FIG. 1(b), these devices will be oriented appropriately upon descent. The curved bottom in the latter further serves to provide areodynamical stability in this orientation. Conceivably, these units may be dropped with some degree of rotation, either initially or sustained during the dop, to provide further orientation stability. Alternatively, the units are dropped in an inflated cushion to break the momentum during impact, as in recent Mars landing experiments. The probes may further be adapted to the surrounding environment by appropriate color and, in FIG. 1(b) The latter might be shaped (as a rock, bush, etc.). Both implementations are shown with solar panels, either folded out in FIG. 1(a) or on the top of the device FIG. 1(b).

The smart VLSI single-chip multi-sensor comprising audio-visual sensing capability is schematically shown in FIG. 2. The section comprising the microphone (μ) and the optical detector (CCD) are shown in the middle, surrounded by sections containing GPS, a microprocessor (CPU; including memory), an AD converter (ADC) for the sensing elements and a wireless digital communications unit.

### DESCRIPTION OF THE PREFERRED EMBODIMENTS

Referring more specifically to the drawings, for illustrative purposes the present invention is embodied in the implementation generally shown in FIG. 1 and FIG. 2. It will be appreciated that the embodiment of the invention may vary as to the particular details of the parts, without departing from the basic concepts as disclosed herein.

Referring to FIG. 1 and FIG. 2, WRS can be realized using modern state of the art silicon sensor and wireless digital communication technology. The heart of the device consists of a smart multi-sensor for audio-visual sensing, for which a sketch of the chip-layout is shown in FIG. 2. In particular, we mention that both accoustic and visual sensing can be integrated on a single silicon chip using standard commercial processes, i.e.: thin membranes (μ) acting as pressure sensors and charge-coupled devices (CCD) for visual reading. This multi-sensor output is connected to an analogue-to-digital converter (ADC) for input to an on-chip microcomputer (CPU) for data analysis. The processor subsequently decides whether to provide data to the wireless network port (WNP) for transmittal over the sensor network to a site for central processing.

Data analysis serves one primary purpose: the selection of anomalous stimuli from the environment for transmittal over the sensor network. Selection criteria are described by thresholds for devitations with respect the beackground signal, e.g., as a function of contrast and motion in visual stimuli. Detection of an anomalous signal will trigger data compression, data labeling with the GPS-coordinates, and submission into the network for transmittal to a site for central processing.

The two embodiments (a) and (b) in FIG. 1 refer to two alternative terrains or wheather conditions. Where desirable and permitted by soft soil, probe can take the form of a pole inserted vertically extending to some height above the ground. Alternatively, the probe can be relatively flat, appropriate where the soil is hard or rocky. A flat probe may also be appropriate as a floating device on very wet soil or during a very wet season. In either case, both the pole and the flat device require measures to assume proper positioning upon aerial droppings by airplane. To this end, it is desirable to place the battery as the more heavy component in the bottom (low center of gravity). In the case of a flat unit (b), furthermore, the bottom may be given a parabolic shape to stabilize orientation during fall-down. Additional orientation stability may be provided by rotation, either initially or forced during fall.

A sketch of the layout of the VLSI smart silicon-integrated multi-sensor is shown in FIG. 2. Here, we emphasize integration of multiple compatible functions on a single VLSI chip, notably so audio-visual sensing capability by a pressure sensor (μ) and an optical sensor (CCD) with on-chip computing (CPU) and memory (not shown) capability. Further integration is envisioned to contain an AD converter (ADC), GPS and a wireless network port (WNP) for connection into a sensor network. Mass-produced VLSI-chips integrating multiple functions greatly reduce manufacturing costs, notably so for volumes of 10⁵ units and up. The envisioned functionality is fairly standard, and exists already in discrete devices in commercial production.

1 A wild-life registration system (WRS) consisting of a wireless network of multi-sensors, with the property that said network spans a two-dimensional grid optimized for detecting and tracking migration trajectories.

2 An WRS as described in claim 1 with the property that said network uses ad-hoc routing and is Internet compatible.

3 A multi-sensor for a sensor network of audio-visual sensing, with the property that said audio-visual sensing capability is integrated onto a single silicon integrated chip.

4 A multi-sensor as described in claim 3 with the property that said multi-sensors a smart sensors, comprising on-chip data analysis for selection of anomalous signals above background.

5 A multi-sensor as described in claim 3 with the property that said silicon chip includes GPS and wireless network ports.

6 An ad-hoc routing algorithm for sending messages over a graph representing a random network of sensors {Sᵢ}ᵢ₌₁^{N} which comprises the selection of a directed sub-graph R*={Sₙ_{₁}, Sₙ_{₂}, . . . , S_{N}} for communications between Sₙ_{₁} to S_{N}, with the property that Sₙ_{ᵢ₊₁} is either of the two alternatives:
(a) Sₙ_{ᵢ₊₁} is the neighbor of Sₙ_{ᵢ} other than Sₙ₋₁ which is closest to S_{N},
(b) Sₙ_{ᵢ₊₁}=Sₙ_{ᵢ₋₁} when Sₙ_{ᵢ}≠S_{N} has Sₙ_{ᵢ₋₁} as its only neighbor.

7 Ad ad-hoc routing algorithm as described in claim 6 with the property that said alternative (a) consists of the following steps:
(1) Sᵢ broadcasts a sollicitation of the labels and coordinates of neighboring sensors;
(2) Sᵢ compares the replies and selects the neighbor Sⱼ that is closest to S_{N};
(3) Sᵢ sends its message and R(k)={Sₙ_{₁}, Sₙ_{₂}, . . . , Sₙ_{ₖ}} to Sⱼ.

8 A method of deployment of a wireless network of sensors which are placed on the ground by aerial droppings from airplanes.

9 A probe comprising a multi-sensor for integration into a wireless sensor network, with the property that said probe is rugged and suitable for aerial droppings by airplane.

10 A probe as described in claim 9, with the property that it has a generally elongated shape to permit vertical insertion into the natural soil.

11 A probe as described in claim 10, with the property that it has a generally flat shape to permit horizontal placement on the natural soil.

12 A method of gathering data on migration trajectories for analysis of collective and predictive behavior with the property that said data are registered using WRS as decribed in claim 1.
